(19) United States
(12) Patent Application Publication
(10) Pub. No.: US 2025/0075801 A1
(43) Pub. Date: Mar. 6, 2025

(54) Recirculation Device

(71) Applicant: Bray International, Inc., Houston, TX (US)

(72) Inventors: Rajan WELLINGTON, Chennai (IN); Amitartha SAHOO, Balasore (IN); Andrew DREDGE, St. Morris (AU); Ramakrishnan VISWANATHAN, Chennai (IN); Thirugnanasambandan KRISHNAN, Kancheepuram (IN)

(21) Appl. No.: 18/819,831

(22) Filed: Aug. 29, 2024

Related U.S. Application Data
(60) Provisional application No. 63/580,151, filed on Sep. 1, 2023.

(51) Int. Cl. F16K 3/02; F16K 37/00; F17D 1/08; F17D 3/12; F17D 5/02

(52) U.S. Cl. CPC F16K 3/0281; F16K 37/0008; F17D 3/12; F17D 1/088; F17D 5/02

(57) ABSTRACT

A system for collecting and allowing transport of media comprising a first pipeline, a bi-directional valve mounted to the first pipeline, and a second pipeline fluidly connected to the bi-directional valve, wherein the second pipeline is fluidly connected to the first pipeline. The system for collecting and allowing transport of media may further comprise a pressure injection system mounted to the second pipeline. The system for collecting and allowing transport of media may further comprise a drain device fluidly connected to the bi-directional valve, wherein the drain device is fluidly connected to the second pipeline. The system for collecting and allowing transport of media may further comprise comprising a non return valve mounted to the second pipeline.

### STATEMENTS REGARDING FEDERALLY SPONSORED RESEARCH OR DEVELOPMENT

Not Application.

### NAMES OF THE PARTIES TO A JOINT RESEARCH AGREEMENT

Not Applicable.

### BACKGROUND

Technical field: The subject matter generally relates to improvements for flow control valves, valve assemblies, and knife gate valve assemblies, and in particular bi-directional valve assemblies.

Flow control valves, such as knife gate valves, regulate flow rate and pressure of media through a pipeline. For example, knife gate valves control the flow of fluids and can be particularly useful in the mining, pulp, and paper industries. Knife gate valves are designed for on-off and isolation services in systems with media having suspended solids. In particular, knife gate valves are well suited for handling slurry as well as viscous, corrosive, and abrasive media.

A push-through knife gate valve, also known as a self-purging or self-cleaning slurry gate valve, may be bidirectional and seal via elastomeric sleeves in the body of the valve. The elastomeric sleeves may become worn and damaged due to use and the cycling of the valve from closed to open and open to closed. A push-through knife gate valve expels or discharges media to the outside environment when the gate transitions from an open-to-close position or a close-to-open position. Discharge of media which is toxic or precious or acidic is inconvenient, costly, may be a safety or environmental hazard, and can present regulatory issues.

### BRIEF SUMMARY

The present disclosure generally relates to embodiments of a recirculation device for collecting and allowing transport of media which has been discharged from a bi-directional valve.

Additionally, the present disclosure relates to embodiments of a method for recirculating media which has been discharged from a bi-directional valve.

Additionally, the present disclosure relates to embodiments of a system for collecting and allowing transport of media which has been discharged from a bi-directional valve.

Additionally, the present disclosure relates to embodiments of a recirculation device configured to prevent discharge of media from a bi-directional valve to the external environment and configured to return the discharged media to a first pipeline connected to the bi-directional valve.

A system for collecting and allowing transport of media comprising a first pipeline, a bi-directional valve mounted to the first pipeline, and a second pipeline fluidly connected to the bi-directional valve, wherein the second pipeline is fluidly connected to the first pipeline. The system for collecting and allowing transport of media may further comprise a pressure injection system mounted to the second pipeline. The system for collecting and allowing transport of media may further comprise a drain device fluidly connected to the bi-directional valve, wherein the drain device is fluidly connected to the second pipeline. The system for collecting and allowing transport of media may further comprise a non return valve mounted to the second pipeline.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this disclosure, and are not to be considered limiting of its scope, for the disclosure may admit to other equally effective embodiments. The figures are not necessarily to scale and certain features and certain views of the figures may be shown exaggerated in scale or in schematic in the interest of clarity and conciseness.

FIG. 1A depicts a partial perspective, cross section view of an exemplary embodiment of a knife gate valve which is fully open.

FIG. 1B depicts a partial perspective, cross section view of an exemplary embodiment of a knife gate valve which is fully closed.

FIG. 1C depicts a partial perspective, cross section view of an exemplary embodiment of a knife gate valve which is in transition between open and closed (or closed to open).

FIG. 2 depicts a perspective view of an exemplary embodiment of a recirculation device or assembly or system connected to a knife gate valve.

FIG. 3 depicts a side, cross section view schematic of an exemplary embodiment of a recirculation device or assembly or system connected to a knife gate valve.

FIG. 4 depicts a partial schematic of an exemplary embodiment of a recirculation device or assembly or system connected to a knife gate valve and having a pressure injection system configured or adapted for auto sensing and auto actuation.

FIG. 5A depicts a perspective view of an exemplary embodiment of a drain device.

FIG. 5B depicts a sectional view of the exemplary embodiment of the drain device of FIG. 5A.

### DETAILED DESCRIPTION OF THE EMBODIMENT(S) SHOWN

The description that follows includes exemplary apparatus, methods, techniques, and instruction sequences that embody techniques of the inventive subject matter. However, it is understood that the described embodiments may be practiced without these specific details.

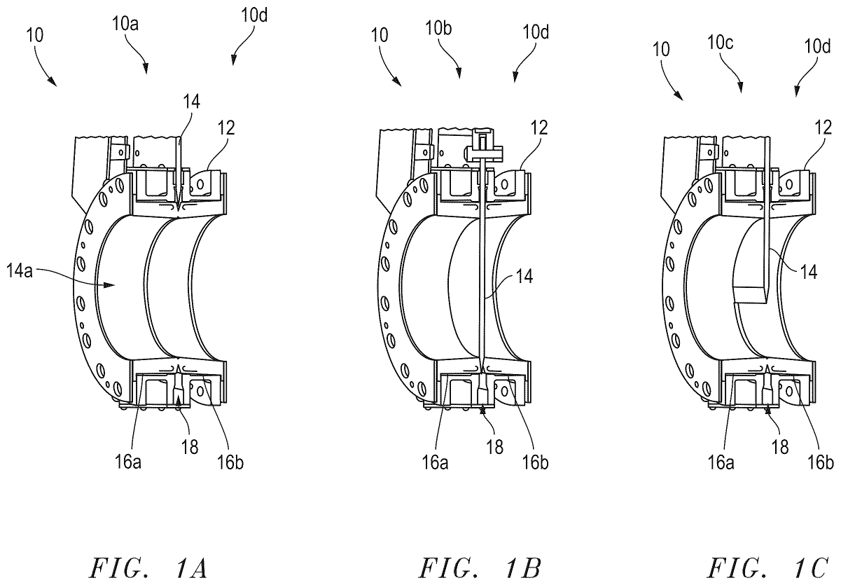

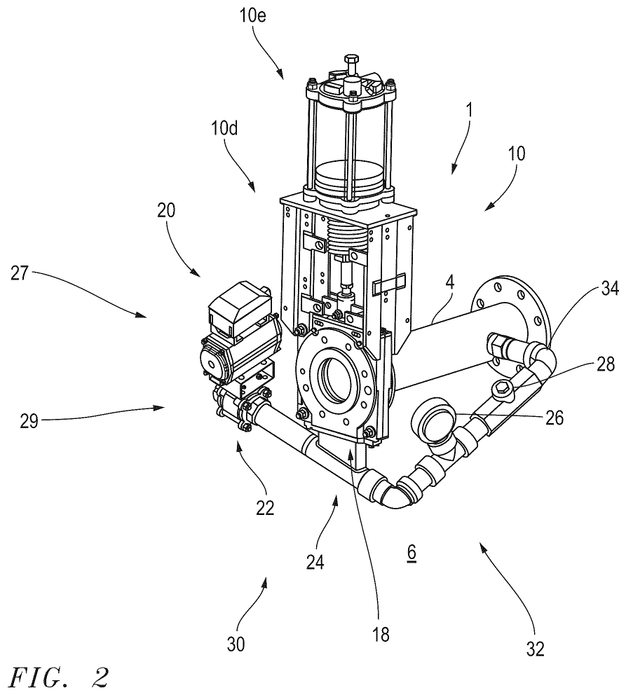

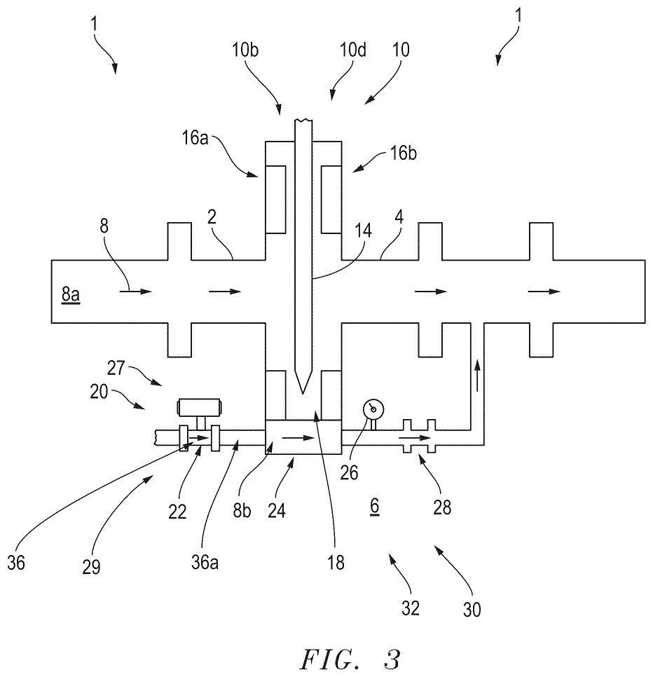

FIG. 1A depicts a partial perspective, cross section view of an exemplary embodiment of a bi-directional valve 10, and specifically a knife gate valve 10d, which is in a fully open position or condition 10a. FIG. 1B depicts a partial perspective, cross section view of an exemplary embodiment of a bi-directional valve 10, and specifically a knife gate valve 10d, which is in a fully closed position or condition 10b. FIG. 1C depicts a partial perspective, cross section view of an exemplary embodiment of a bi-directional valve 10, and specifically a knife gate valve 10d, which is in a transition position or condition 10c between fully open 10a and fully closed 10b or fully closed 10b to fully open 10a. Referring to FIGS. 1A-1C, when the gate 14 is in the open position or condition 10a, the retractable gate 14 ensures that only the elastomer sleeves or seats 16a, 16b, one of each on the upstream and downstream side of valve body 12, contact the flowing media 8a (shown in FIG. 3), which may be, by way of example only, a slurry. Bi-directional valve 10 may have a port or passageway 14a defined by the bi-directional valve 10 which may be adapted or configured to axially align with first or main pipeline 1 (shown in FIGS. 2-3) for flow of media 8a through the bi-directional valve 10. When the gate 14 is in the closed position or condition 10b, the gate 14 is in contact with the elastomer sleeves 16a, 16b, ensuring no leakage of media 8a to downstream pipeline or piping 4 (see, e.g. FIG. 2). Due to the push-through design, which may also be described as a discharge design and discharge features, of the valve 10d, when the gate 14 is in transition 10c from close-to-open or open-to-close, a volume of media 8a is expelled or discharged or flows from the bottom cavity 18 defined by the valve body 12 and may then be controlled or diverted by a drain device 24, such as by way of example only, a drain plate or drain pan or drain bucket, connected directly or indirectly to the bottom cavity 18. By way of example only, drain device 24 may be fluidly connected to bottom cavity 18. By way of example only, drain device may be removably mounted to valve body 12 for receiving media 8a which is pushed through bottom cavity 18. By way of example only, drain device 24, may be mounted to valve body 12 with screws, bolts, and/or other fasteners.

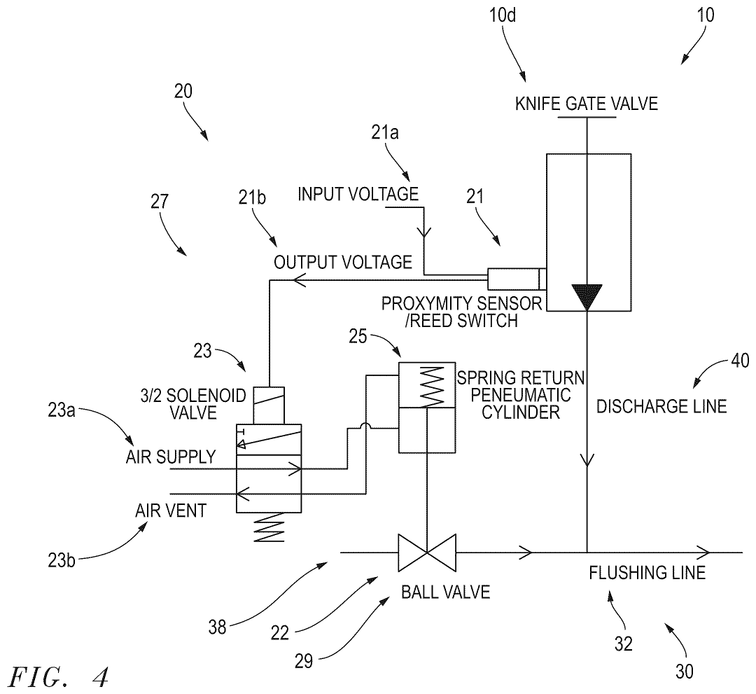

FIG. 2 depicts a perspective view of an exemplary embodiment of a recirculation device or assembly or system 30 connected to bi-directional valve 10, specifically a knife gate valve 10d. FIG. 3 depicts a side, cross section view schematic of an exemplary embodiment of a recirculation device or assembly or system 30 connected to a bi-directional valve 10, specifically a knife gate valve 10d. Bi-directional valve 10 may be adapted to or configured to mount coaxially into a first or main pipeline or other suitable conduit 1. Bi-directional valve 10 may have or define a port or passageway 14a (shown in FIG. 1) which may be adapted or configured to axially align with a first or main pipeline 1 for flow of media 8 through the bi-directional valve 10. Recirculation device or assembly or system 30 may be used for bi-directional valves 10 which discharge a volume of media 8a, such as, by way of example only, knife gate valves 10d and double block and bleed (“DBB”) valves (not shown). The recirculation device or assembly 30 may be used with valves in different orientations such as, by way of example only, vertical and horizontal valve orientations. The recirculation device 30 directs the media 8a discharged from the knife gate valve 10d, which is in a vertical valve orientation 10e as depicted in FIGS. 2-3, to the downstream side of the pipeline or piping 4 of a first or main pipeline 1. The recirculation device 30 may comprise a drain device 24, such as a drain bucket into which the media flows. The recirculation device 30 may further comprise a pressure injection system 20, which may be, by way of example, configured or adapted for auto sensing and auto actuation, and which may comprise a flushing valve 22, which may be by way of example, configured or adapted for auto sensing and auto actuation, that opens for flushing the media 8b collected by drain device 24 to the downstream pipeline or piping 4. By way of example only, pressure injection system 20 may comprise an actuator 27 and a control device 29. The closed position 10b of the knife gate valve 10d may be sensed by a position sensor 21 (shown in FIG. 4), such as a proximity sensor or reed switch, and the flushing valve 22 opens for flushing when the knife gate valve 10d is in the closed position 10b. The self-draining and recirculating features of the exemplary embodiment ensure that media 8b is not discharged into the outside environment 6. The non return valve 28 ensures that there is no back pressure to the drain device 24 from the downstream pipeline 4 of the pipeline 1. By way of example only, the non return valve 28 may be a check valve. The recirculation device 30 may also comprise a pressure gauge 26. Pressure gauge 26 may indicate whether the knife gate valve 10d is leaking when in the closed position 10b. Pressure gauge 26 may indicate whether the knife gate valve 10d is leaking when in the open position 10c. Recirculation device 30 may comprise a second pipeline or flushing pipeline 32. Second pipeline or flushing pipeline 32 may comprise fitting 34. By way of example only, second pipeline or flushing pipeline 32 may fluidly connect pressure injection system 20, drain device 24, pressure gauge 26, and non return valve 28.

FIG. 3 depicts a side, cross section view schematic of an exemplary embodiment of a recirculation device or assembly 30 connected to bi-directional valve 10, specifically a knife gate valve 10d. Knife gate valve 10d controls the flow 8 of media 8a in the first or main pipeline 1 from the upstream pipeline 2 to the downstream pipeline 4. Recirculation device 30 may comprise a second pipeline or flushing pipeline 32. The pressure injection system 20 uses flushing media 36a, which may be, by way of example only, water, to provide positive pressure to one side of the drain device 24 which aids the flow or movement 36, and therefore the recirculation, of the discharged media 8b back to the main pipeline 1 at the downstream pipeline 4 while the knife gate valve 10d is in a closed condition 10b. Instances of damage to the seats or sleeves 16a, 16b may be detected by pressure gauge 26. When the gate 14 is open 10a, the seats or sleeves 16a, 16b may allow media 8a to flow through the sleeves 16a, 16b in a main pipeline 1 from upstream pipeline 2 to downstream pipeline 4. When at least one of the sleeves 16a, 16b are damaged, the media 8a is discharged or flows via the drain device 24 and pressure gauge 26 indicates high pressure to evidence leaking which indicates repair or maintenance of the valve may be needed. The recirculation device 30 may comprise a pressure injection system 20, which may be, by way of example only, configured or adapted for auto sensing and auto actuation, which may comprise a flushing valve 22, which may be, by way of example only, configured or adapted for auto sensing and auto actuation, that opens for flushing the media collected by drain device 24 to the downstream pipeline or piping 4. By way of example only, pressure injection system 20 may comprise an actuator 27 and a control device 29. When the closed position 10b of the knife gate valve 10d is sensed, the flushing valve 22 opens for flushing. By way of example only, the flushing valve 22 may be a ball valve. A sensor 21 (shown in FIG. 4), which may be, by way of example only, a proximity switch, may sense the gate 14 position, particularly whether the gate 14 is open 10a and whether the gate is closed 10b. The sensor 21 (shown in FIG. 4) is communicably connected or electrically connected or linked to the actuated autosensing flushing valve 22, which may be via a dual coil solenoid. The recirculation device or assembly 30 can be adapted to existing valve installations.

Referring to FIGS. 2-3, recirculation device 30 collects and allows transport of media 8a which is discharged from a bi-directional valve 10 connected to a first or main pipeline 1 and returns discharged media 8b to the first or main pipeline 1. Recirculation device 30 may comprise a pressure injection system 20, a drain device 24 fluidly connected to the pressure injection system 20, and a non return valve 28 fluidly connected to the drain device 24. By way of example only, elements which are fluidly connected may be directly or indirectly connected such that fluid and other media, such as a slurry having solids or precipitates, is able to flow between the elements. By way of example only, fluid connection may be by pipeline(s). Fluid connection, by way of example only, may be by pipe(s), fitting(s), flange(s), and/or pipe spool(s). By way of example only, drain device 24 may be fluidly connected to bottom cavity 18 (shown in FIG. 1) of valve body 12. By way of example only, drain device 24 may be removably mounted to valve body 12 for receiving media 8a which is pushed through bottom cavity 18. By way of example only, a gasket or seal may be positioned between the valve body 12 and drain device 24 in order to prevent leakage. By way of example only, drain device 24 may have an inlet port and an outlet port and flushing pipeline 32 may connect to the drain device at the inlet port and the outlet port. By way of example only, pressure injection system 20 may comprise an actuator 27 and a control device 29.

Recirculation device 30 may comprise a pressure gauge 26 fluidly connected to the drain device 24 and the non return valve 28. Drain device 24 is fluidly connected to a bi-directional valve 10. By way of example only, bi-directional valve 10 may be a knife gate valve 10d. Pressure injection system 20 may comprise a flushing valve 22. By way of example only, flushing valve 22 may be a ball valve. Non return valve 28 is fluidly connected to a downstream pipeline 4 of the bi-directional valve 10, and downstream pipeline 4 is fluidly connected to the bi-directional valve 10. Recirculation device 30 may comprise a flushing pipeline 32 which fluidly connects the pressure injection system 20 to the drain device 24, and flushing pipeline 32 fluidly connects the non return valve 28 to the drain device 24. Flushing pipeline 32 fluidly connects to the downstream pipeline 4 and fluidly connects the non return valve 28 to the downstream pipeline 4.

Referring to FIGS. 2-3, a system for collecting and allowing transport of media may comprise a first pipeline 1, a bi-directional valve 10 mounted to the first pipeline 1, and a second pipeline 32 fluidly connected to the bi-directional valve 10, wherein the second pipeline 32 is fluidly connected to the first pipeline 1. A system for collecting and allowing transport of media may comprise a means for injecting pressure into the second pipeline. By way of example only, means for injecting pressure into the second pipeline may comprise a pressure injection system 20 mounted to the second pipeline 32. Drain device 24 may be fluidly connected to the bi-directional valve 10 and drain device 24 may be fluidly connected to the second pipeline 32. A non return valve 28 may be mounted to the second pipeline 32.

Referring to FIGS. 2-3, recirculation device 30 enables or allows fluid connection between the bi-directional valve 10 (or knife gate valve 10d), the pressure injection system 20 with the flushing valve 22, the drain device 24, the pressure gauge 26, the non return valve 28, the first or main pipeline 1 and the second or flushing pipeline 32. The pressure injection system 20 (having the flushing valve 22) is connected at one end to the drain device 24 via the second pipeline 32. The drain device 24 is fluidly connected at a top of the drain device 24 to the bottom cavity 18 of the valve 10, and is further fluidly connected at a second end to the pressure gauge 26 via the second pipeline 32. Pressure gauge 26 may be mounted onto the second pipeline 32, as located between the drain device 24 and the non return valve 28. The pressure gauge 26 is further fluidly connected to the non return valve 28 via the second pipeline 32, at a first end of the non return valve 28. The second end of the non return valve 28 is fluidly connected to the downstream pipeline 4 of the main pipeline 1.

FIG. 4 depicts a partial schematic of an exemplary embodiment of a recirculation device or assembly or system 30 connected to a knife gate valve 10d having a pressure injection system 20 configured or adapted for auto sensing and auto actuation. By way of example only, pressure injection system 20 may comprise a solenoid valve 23 which is connected or attached to a single acting pneumatic cylinder 25 to operate the flushing valve 22. Recirculation device or assembly or system 30 is connected to bi-directional valve 10, specifically a knife gate valve 10d. Pressure injection system 20 may have a sensor 21, which by way of example only, may be a proximity sensor or reed switch. Sensor 21 may have an input voltage 21a and an output voltage 21b. Sensor 21 may be communicably connected or electrically connected or linked to solenoid valve 23, which may be by way of example only, a 3/2 solenoid valve. Solenoid valve 23 may have an air supply line 23a and an air vent line 23b. Air supply line 23a and air vent line 23b may be connected to a pneumatic cylinder 25, such as by way of example only, a spring return pneumatic cylinder. Pneumatic cylinder 25 is connected to flushing valve 22, which may be by way of example only, a ball valve, for driving the flushing valve 22 to an open and close position. A flushing media feed or source 38 may be connected to flushing valve 22. When flushing valve 22 is in an open position, flushing media 36a (shown in FIG. 3) may flow through flushing line 32. By way of example only, knife gate valve 10d may be mounted to a first or main pipeline 1 (shown in FIGS. 2-3). A second or flushing pipeline 32 may be fluidly connected to the bi-directional valve 10. By way of example only, a third or discharge pipeline 40 may connect to the knife gate valve 10d and the flushing pipeline 32. Knife gate valve 10d may be fluidly connected to the second or flushing pipeline 32 by a third or discharge pipeline 40. Third or discharge pipeline 40 may be fluidly connected to the knife gate valve 10d and the second or flushing pipeline 32, wherein the second or flushing pipeline 32 is fluidly connected to the first pipeline 1 (shown in FIGS. 2-3). By way of example only, drain device 24 may be mounted to or fluidly connected to third or discharge pipeline 40. By way of example only, other means for injecting pressure into the second pipeline are possible aside from the exemplary embodiment of a pressure injection system 20 shown in FIG. 4. By way of example only, means for injecting pressure into the second pipeline may comprise an actuator 27 and control device 29. Control device 29 may be a flushing valve 22. Control signal to a control device 29 may be, by way of example only, electric voltage or current, pneumatic pressure, hydraulic fluid pressure, or human power. By way of example only, the energy source for the actuator 27 may be electric current, hydraulic pressure, or pneumatic pressure. Actuator 27 may receive a control signal and convert the energy source into mechanical motion to drive a control device 29 to allow or enable flushing of the second pipeline 32. Flushing media 36a (shown in FIG. 3) may be supplied by flushing media source or feed 38 which is connected to flushing valve 22. Flushing media source or feed 28 may be fluidly connected to flushing valve 22 via flushing fluid inlet to flushing valve 22. By way of example only, elements which are fluidly connected may be directly or indirectly connected such that fluid and other media, such as a slurry having solids or precipitates, is able to flow between the elements. By way of example only, fluid connection may be by pipeline(s). Fluid connection, by way of example only, may be by pipe(s), fitting(s), flange(s), and/or pipe spool(s).

When the knife gate valve 10d is in a closed position 10b, sensor 21 senses the gate position and give output voltage 21b to the coil of solenoid valve 23. A port of solenoid valve opens and supplies air via air supply line 23a to the pneumatic cylinder 25 to open the flushing valve 22, which may be a ball valve. When the valve is in an open position, sensor 21 cuts the voltage supply so solenoid valve 23 closes flushing valve 22, which may be a ball valve, by cutting the air supply from source.

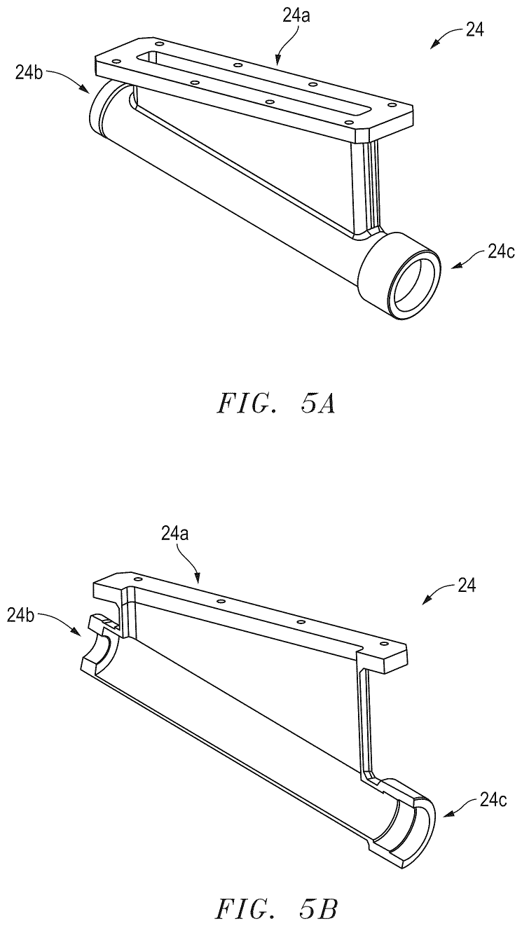

FIG. 5A depicts a perspective view of an exemplary embodiment of a drain device 24. FIG. 5B depicts a sectional view of the exemplary embodiment of the drain device 24 of FIG. 5A. By way of example only, drain device 24 may be a drain bucket as depicted in FIGS. 5A & 5B. By way of example only, a gasket or seal may be positioned between the valve body 12 (shown in FIG. 2) and drain device 24 in order to prevent leakage. By way of example only, drain device may have a flange or valve mounting flange 24a. By way of example only, drain device 24, may be removably mounted to valve body 12 (shown in FIG. 2) with screws, bolts, and/or other fasteners. By way of example only, drain device 24 may have an inlet port or flushing inlet 24b and an outlet port or flushing outlet 24c and flushing pipeline 32 (shown in FIGS. 2-3) may connect to the drain device at the inlet port 24b and the outlet port 24c.

While the exemplary embodiments are described with reference to various implementations and exploitations, it will be understood that these exemplary embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An apparatus for collecting and allowing transport of media comprising:
a pressure injection system;
a drain device fluidly connected to the pressure injection system; and
a non return valve fluidly connected to the drain device.

2. The apparatus of claim 1, further comprising:
a pressure gauge fluidly connected to the drain device and the non return valve.

3. The apparatus of claim 2, wherein the drain device is fluidly connected to a bi-directional valve.

4. The apparatus of claim 3, wherein the bi-directional valve is a knife gate valve.

5. The apparatus of claim 2, wherein the pressure injection system comprises a flushing valve.

6. The apparatus of claim 5, wherein the flushing valve is a ball valve.

7. The apparatus of claim 5, wherein the non return valve is fluidly connected to a downstream pipeline of the bi-directional valve, and wherein the downstream pipeline is fluidly connected to the bi-directional valve.

8. The apparatus of claim 2, further comprising a flushing pipeline, wherein the flushing pipeline fluidly connects the pressure injection system to the drain device, wherein the flushing pipeline fluidly connects the non return valve to the drain device.

9. The apparatus of claim 6, further comprising a sensor communicably connected to the pressure injection system.

10. A method for recirculating media comprising the steps of:
collecting a volume of discharged media from a bi-directional valve in a drain device, wherein the drain device is fluidly connected to the bi-directional valve, wherein a pipeline is fluidly connected to the bi-directional valve, wherein the pipeline comprises:
an upstream pipeline of the bi-directional valve; and
a downstream pipeline of the bi-directional valve;
sensing the closed position of the bi-directional valve; and
flushing the volume of media discharged with a flushing media through a flushing pipeline fluidly connected to the drain device and fluidly connected to the downstream pipeline of the bi-directional valve toward the downstream pipeline of the bi-directional valve.

11. The method of claim 10, further comprising the step of:
preventing backflow of the volume of discharged media and the flushing media through the flushing pipeline to the drain device.

12. The method of claim of claim 11, further comprising the step of:
gauging the pressure in the flushing pipeline.

13. The method of claim 12, further comprising the steps of:
wherein the step of preventing backflow of the volume of media and the flushing media through the flushing pipeline to the drain device comprises a non return valve fluidly connected to the flushing pipeline and the drain device.

14. The method of claim 13, further comprising the steps of:
wherein the step of gauging the pressure in the flushing pipeline comprises a pressure gauge fluidly connected to the flushing pipeline between the drain device and the non return valve.

15. A system for collecting and allowing transport of media comprising:
a first pipeline;
a bi-directional valve mounted to the first pipeline; and
a second pipeline fluidly connected to the bi-directional valve, wherein the second pipeline is fluidly connected to the first pipeline.

16. The system of claim 15, further comprising:
a means for injecting pressure into the second pipeline.

17. The system of claim 15, further comprising a pressure injection system mounted to the second pipeline.

18. The system of claim 17, further comprising:
a drain device fluidly connected to the bi-directional valve, wherein the drain device is fluidly connected to the second pipeline.

19. The system of claim 18, further comprising a non return valve mounted to the second pipeline.

20. The system of claim 19, further comprising a pressure gauge mounted to the second pipeline.

21. The system of claim 20, further comprising:
a sensor for sensing a position of the bi-directional valve, wherein the sensor is communicably connected to the pressure injecting system.

22. The system of claim 21, wherein the pressure injecting system further comprises a flushing valve.

23. The system of claim 17, further comprising:
a third pipeline fluidly connected to the first pipeline, wherein the third pipeline is fluidly connected to the second pipeline.

24. The system of claim 23, further comprising:
a drain device mounted to the third pipeline.
